(19) United States
(12) Patent Application Publication
(10) Pub. No.: US 2022/0108189 A1
(43) Pub. Date: Apr. 7, 2022

(54) GRAPH SUMMARIZATION APPARATUS, GRAPH SUMMARIZATION METHOD AND PROGRAM

(71) Applicant: NIPPON TELEGRAPH AND TELEPHONE CORPORATION, Tokyo (JP)

(72) Inventors: Yuka HASHIMOTO, Musashino-shi, Tokyo (JP); Yoichi MATSUO, Musashino-shi, Tokyo (JP)

(21) Appl. No.: 17/421,128

(22) PCT Filed: Jan. 10, 2020
(86) PCT No.: PCT/JP2020/000596

§ 371 Date: Jul. 7, 2021

(30) Foreign Application Priority Data
Jan. 23, 2019 (JP) 2019-009760

(51) Int. Cl. G06N 5/02; G06F 16/901; G06K 9/62

(52) U.S. Cl. CPC G06N 5/02; G06K 9/6296; G06F 16/9024

(57) ABSTRACT

A graph summarizing apparatus includes a computation unit configured to compute, when a graph changes, importance degrees based on factor degrees of nodes in the graph before the change, for the nodes of the graph after the change, each of the nodes having a factor degree indicating an extent of a factor on a state of the graph, the graph having edges each of which has a weight indicating a strength of a causal relationship between the nodes; a selection unit configured to select a first node having the importance degree or less than or equal to a threshold as a candidate for deletion; and a deletion unit configured to delete the first node, and achieves graph summarization capable of suppressing a decrease in accuracy of factor estimation by a causal graph.

### TECHNICAL FIELD

The present invention relates to a graph summarizing apparatus, a graph summarizing method, and a program.

### BACKGROUND ART

In system operation, an automation technology for failure handling has been considered to reduce an operation load of an operator. In particular, when a failure occurs, it often requires a huge amount of time to manually identify a factor of the failure, and study on a technology of failure factor estimation is thus important. These technologies are often performed using causal graphs such as a Bayesian Network (Non Patent Literature 1) and a decision tree (Non Patent Literature 2).

In the future, it is anticipated that a system is increased in size and complicated due to penetration of a virtualization technology. Thus, it is anticipated that the number of alerts or abnormal events at the time of occurrence of a failure increases and a causal relationship thereof is also complicated. It is anticipated that this results in large and complex graphs in the factor estimation technology as described above.

As a general technology for graphs, graph summarization technologies have been proposed that extract and simplify critical portions of a graph. If this can be applied to a causal graph, factor estimation is made on a graph after summarization using the graph summarization to estimate rough factors, and information before summarization is returned for only vicinities of events as the factors to make factor estimation again, so that it can be expected to reduce the computation time. When the number of events that are subject to the factor estimation is reduced, the computation time is reduced, and accuracy is also ensured by the two-step estimation.

With respect to the graph summarization, a study directed to a relationship between individuals or communities and analysis of cited relationships of articles has been performed (Non Patent Literature 3), but there are few technologies for applying the graph summarization to a causal graph for the purpose of factor estimation. Non Patent Literature 4 proposes a technology for streamlining estimation by simplifying the Bayesian Network from structural information.

### CITATION LIST

### Non Patent Literature

Non Patent Literature 1: E. R. J. Hruschka, M. do Carmo Nicoletti, V. A. de Oliveira, and G. M. Bressan, “Markov-blanket based strategy for translating a bayesian classifier into a reduced set of classification rules,” in Proceedings of the 7th International Conference on Hybrid Intelligent Systems (HIS '07), pp. 192-197, 2007.
Non Patent Literature 2: A. X. Zheng, J. Lloyd, and E. Brewer, “Failure diagnosis using decision trees,” in proceedings of the First International Conference on Autonomic Computing (ICAC '04), pp. 36-43, 2004.
Non Patent Literature 3: Y. Liu, T. Safavi, A. Dighe and D. Koutra, “Graph Summarization Methods and Applications: A Survey, ACM Computing Surveys,” 51(3), pp. 1-34, 2018.
Non Patent Literature 4: M. Shiba, A. Takahashi, S. Aoki, H. Tsuji and S. Inoue, “Numerical experimentation on structure simplification in Bayesian network,” 2009 IEEE International Conference on Systems, Man and Cybernetics, pp. 4698-4703, 2009.

### SUMMARY OF THE INVENTION

### Technical Problem

While there are a few methods taking application of graph summarization to a causal graph into account, all the methods use only structural information of graphs, such as deleting a node at an end, or grouping a plurality of nodes sharing a neighboring node. Furthermore, only a guideline is indicated, and a method for determining a node to be deleted or nodes to be grouped is not clearly indicated.

On the other hand, with regard to the likelihood that each node becomes a factor in system operation, information on whether the node was a factor in a failure in the past needs to be considered in addition to the structural information of the graph, and thus there is a problem in the related art that accuracy of the factor estimation of the causal graph lowers. Further, a technology directed to a relationship between individuals or communities and a cited relationship between articles is a specialized method for their analysis, so that summarization focusing on influences of nodes such as the orders of nodes is performed.

On the other hand, in factor estimation by a causal graph, the likelihood that each node becomes a factor is important and thus, there is a problem that the accuracy of the factor estimation by the causal graph drops even in the existing technologies described above.

As described above, graph summarization that is suitable for factor estimation by a causal graph in system operation cannot be achieved by the existing technologies alone.

The present invention has been made in view of the above points, and has an object to achieve graph summarization capable of suppressing reduction in accuracy of factor estimation by a causal graph.

### Means for Solving the Problem

To solve the above problems, a graph summarizing apparatus has a computation unit configured to compute, when a graph changes, importance degrees based on factor degrees of nodes in the graph before the change, for the nodes of the graph after the change, each of the nodes having a factor degree indicating an extent of a factor on a state of the graph, the graph having edges each of which has a weight indicating a strength of a causal relationship between the nodes; a selection unit configured to select a first node having the importance degree of less than or equal to a threshold as a candidate for deletion; and a deletion unit configured to delete the first node.

### Effects of the Invention

Graph summarization capable of suppressing a decrease in accuracy of factor estimation by a causal graph can be achieved.

### BRIEF DESCRIPTION OF DRAWINGS

FIG. 1 is a diagram illustrating an exemplary hardware configuration of a failure factor estimation apparatus 10 according to an embodiment of the present invention.

FIG. 2 is a diagram illustrating an exemplary functional configuration of the failure factor estimation apparatus 10 according to the embodiment of the present invention.

FIG. 3 is a flowchart for explaining an example of a processing procedure executed by the failure factor estimation apparatus 10.

FIG. 4 is a diagram illustrating a first example of a graph structure used to describe determination of weights.

FIG. 5 is a diagram illustrating a second example of a graph structure used to describe determination of weights.

FIG. 6 is a diagram illustrating a graph before summarization in evaluation of the present embodiment.

FIG. 7 is a diagram illustrating a graph after summarization in the evaluation of the present embodiment.

FIG. 8 is a diagram illustrating a heat map of a difference in factor degrees between any nodes in the graph after summarization.

### DESCRIPTION OF EMBODIMENTS

Hereinafter, an embodiment of the present invention will be described with reference to the drawings. In order to solve the problem of increase in computation time and reduction in accuracy, the present embodiment discloses a graph summarizing method taking into account points important in summarization of a causal graph, and a failure factor estimation apparatus 10 that executes the graph summarizing method. The failure factor estimation apparatus 10 executes the following steps in response to occurrence of a failure in an information and communication technology (ICT) system to be monitored (hereinafter simply referred to as a “system”).

Step 1: Extract an event from log data output from the system at the present (a certain period of time from the present to the past). When an abnormal event is extracted from the log data, the abnormal event may be extracted using log templating. Alternatively, if the system explicitly outputs an abnormal event (alert), rather than extracting the event from the log data, each type of alerts may be extracted as an abnormal event. Note that for the log templating, for example, “T. Kimura et. al., ‘Spatio-temporal Factorization of Log Data for Understanding Network Events,’ IEEE INFOCOM 2014, pp. 610-618, 2014”, or the like may be referenced.

Step 2: Combine event information in similar failures in the past with event information for the event extracted in step 1 to create a causal graph that represents a causal relationship of the event. For creation of the causal graph that indicates the causal relationship of the event, for example, “P. Chen, Y. Qi, P. Zheng and D. Hou, ‘CauseInfer: Automatic and Distributed Performance Diagnosis with Hierarchical Causality Graph in Large Distributed Systems,’ IEEE INFOCOM 2014, pp. 1887-1895, 2014,” “B. Zong, Y. Wu, J. Song, A. K. Singh, H. Cam, J. Han, and X. Yan, ‘Towards scalable critical alert mining,’ in Proceedings of the 20th ACM SIGKDD international conference on Knowledge discovery and data mining (KDD '14), pp. 1057-1066, 2014”, or the like may be referenced.

Step 3: Summarize the graph created in step 2.

Step 4: Estimate a factor using the graph after summarization. For factor estimation, for example, “B. Zong, Y. Wu, J. Song, A. K. Singh, H. Cam, J. Han, and X. Yan, ‘Towards scalable critical alert mining,’ in Proceedings of the 20th ACM SIGKDD international conference on Knowledge discovery and data mining (KDD '14), pp. 1057-1066, 2014”, or the like may be referenced.

Step 5: Return to the information before summarization for only a vicinity of the event estimated to be a factor in step 4, and estimate a factor again. In this way, a failure factor is estimated.

The present embodiment focuses on the graph summarizing technology in step 3 above and proposes a new technology. There are three important points below in summarization of a causal graph used in factor estimation.

(1) A node that is likely to be a factor is left behind after summarization.
(2) There is less change in results of the factor estimation before and after summarization.
(3) The graph after summarization does not have a cycle structure.

The failure factor estimation apparatus 10 according to the present embodiment performs graph summarization applicable in factor estimation by a causal graph by taking the above points (1) to (3) into account. The present embodiment is executed in the following steps.

Step 1: Detect a node having a low importance degree taking the point (1) into account

Step 2: Determine edges and their weights of the graph after removing the relevant node taking the point (2) into account
Step 3: Determine whether to delete the detected node taking the point (3) into account

### Problem Setting

Let a causal graph G be G=(V(G),E(G),f_{G}). However, V(g)={v₁, . . . , v_{N(G)}} is a set of nodes of the graph G, and each of the nodes represents an alert generated during a failure or an event extracted from log data during a failure and has a factor degree. The factor degree is an index indicating an extent to which a node is a factor on a current state (structure) of the causal graph G. Note that in the present embodiment, each of an alert generated during a failure and an event extracted from log data during a failure is referred to as an event. N(G) represents the number of nodes of the graph G, E(G)={e_{j, k}|_{j, k}=1, . . . , N(G)} represents a set of edges of the graph G, and ej, k represents an edge from a node vⱼ to a node vₖ. Let f_{G}: E(G)→R₊ be a function representing a weight of an edge of G. However, R₊ represents a set of all real numbers greater than or equal to 0. A weight of an edge indicates the strength of a causal relationship between nodes connected by the edge. That is, the weight of an edge indicates a level of probability that an event factor related to a node on the destination of the edge is an event related to a node on the source of the edge. An adjacency matrix A(G) of G is defined by A(G)=[f_{G}(e_{j,k})]_{j,k}.

In system operation, when a first failure occurs, a causal graph G₁ is created. When a similar failure then occurs, information about a second failure is added to information about the first failure to create a causal graph G₂ that satisfies V(G₁)⊆V(G₂) (the state (structure) of the graph G₁ changes to the graph G₂). This processing is done every time a failure occurs, so that a column {Gᵢ}ᵢ=1^{∞} of graphs for similar failures is created. Further, let a set of events generated during an i-th failure be Rᵢ⊆V(Gᵢ), and let a set column {Rᵢ}ᵢ₌₁^{∞} be created. It is assumed that when i increases, a causal relationship between events is fixed to converge to a causal graph that represents a true causal relationship. It is also assumed that when i increases, it becomes possible to determine whether each generated event is a noise and events converges to a true generated event. That is, it is assumed that there exist G=(V(G),E(G),f_{G}) and R satisfying the following equations.

$${lim}_{i \to ∞} V ( {G}_{i} ) = V ( G ) , {lim}_{i \to ∞} E ( {G}_{i} ) = E ( G ) , \\ {lim}_{i \to ∞} {f}_{{G}_{i}} = {f}_{G} ( EACH POINT ) \\ {lim}_{i \to ∞} {R}_{i} = R \qquad [ Math . 1 ]$$

Here, when an upper limit ∩ₖ₌₁^{∞}∪ᵢ₌ₖ^{∞}Sᵢ and a lower limit ∩ₖ₌₁^{∞}∪ᵢ₌ₖ^{∞}Sᵢ match with respect to a set column {Sᵢ}ᵢ=1^{∞}, let the relation be expressed as ∩ₖ₌₁^{∞}∪ᵢ₌ₖ^{∞}Sᵢ i=∩ₖ₌₁^{∞}∪ᵢ₌ₖ^{∞}Sᵢ=limᵢ→^{∞}Sᵢ.

In the limit graph G, let a probability space (Ω,F,p) be determined. Here, let Ω be a set group including all subsets of V(G). In addition, a probability variable Xⱼ: Ω→{0,1} for each vⱼ ϵV(G) will be determined by Xⱼ(ω)=1 when vⱼϵω is satisfied and determined by Xⱼ(ω)=0 when vⱼϵω is not satisfied. Let f_{G}(e_{j, k})=p({Xₖ=1}|{Xⱼ=1}) be satisfied. For each i, f_{Gi} is defined by an existing technique with a function approximating f_{G}.

At this time, an approximation Pi(vⱼ;Rᵢ) of a sum Σ_{vilϵRi}p{X₁=1}|{Xⱼ=1} of probabilities that an event vₗϵRᵢ occurs when an event vⱼϵV(Gᵢ) occurs is used as a factor degree of vⱼ, and it is estimated that an event having a higher factor degree is the main factor during the i-th failure. Here, Pᵢ is defined as follows.

$${P}_{i} ( v ; \{ v \} ) = 1 , \\ {P}_{i} ( {v}_{k} ; {R}_{i} ) = {\sum }_{v ∈ {R}_{i}} ( 1 - {\prod }_{{e}_{k , l} ∈ E ( {G}_{i} )} ( 1 - {P}_{i} ( {v}_{l} ; \{ v \} ) {f}_{{G}_{i}} ( {e}_{k , l} ) ) ) \qquad [ Math . 2 ]$$

For the mathematical equations, for example, “B. Zong, Y. Wu, J. Song, A. K. Singh, H. Cam, j. Han, and X. Yan, ‘Towards Scalable Critical Alert Mining,’ in Proceedings of the 20th ACM SIGKDD international conference on Knowledge discovery and data mining (KDD '14), pp. 1057-1066, 2014”, or the like may be referenced.

At this time, lim_{i→∞}Pᵢ(⋅;Rᵢ)=P(⋅;R) (each point) is satisfied. Here,

$$P ( v ; \{ v \} ) = 1 , \\ P ( {v}_{k} ; R ) = {\sum }_{v ∈ R} ( 1 - {\prod }_{{e}_{k , l} ∈ E ( G )} ( 1 - P ( {v}_{l} ; \{ v \} ) {f}_{G} ( {e}_{k , l} ) ) ) \qquad [ Math . 3 ]$$

are satisfied.

If a sufficient number of similar failures occur, G* and R* which satisfy G*≈G and R*≈R are obtained, and the main factor for the failure is determined by computing P*(⋅;R*) using the G* and the R* However, until G* and R* are obtained, factor estimation needs to be made using information obtained at the time for estimating the main factor as fast and accurately as possible. Thus, it is considered to achieve the above by summarizing Gᵢ using information of G₁, . . . , Gᵢ₋₁, creating G′ᵢ that satisfies V(G′ᵢ)⊂V(Gᵢ), and making factor estimation on G′ᵢ.

Failure Factor Estimation Apparatus 10

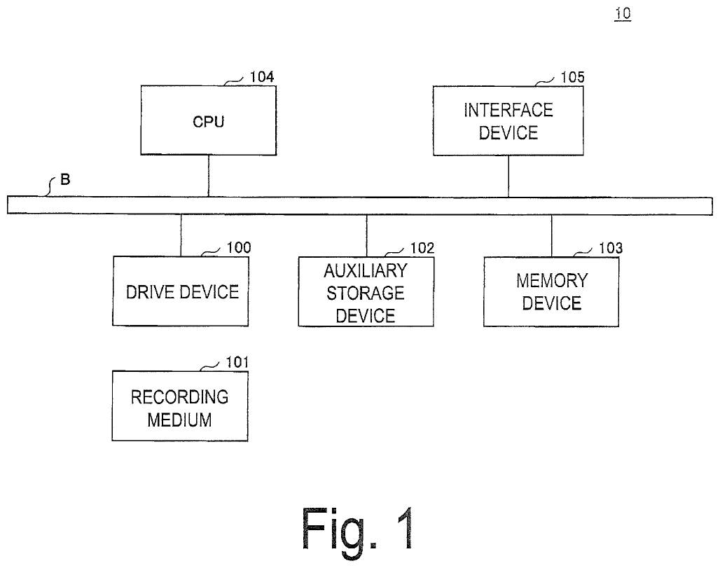

The failure factor estimation apparatus 10 based on the above consideration will be described. FIG. 1 is a diagram illustrating an exemplary hardware configuration of the failure factor estimation apparatus 10 according to the present embodiment of the present invention. The failure factor estimation apparatus 10 in FIG. 1 is a computer that includes a drive device 100, an auxiliary storage device 102, a memory device 103, a CPU 104, an interface device 105, and the like which are connected to each other by a bus B.

A program that realizes processing of the failure factor estimation apparatus 10 is provided through a recording medium 101 such as a CD-ROM. When the recording medium 101 storing the program is set in the drive device 100, the program is installed on the auxiliary storage device 102 from the recording medium 101 through the drive device 100. However, the installation of the program does not necessarily need to be performed from the recording medium 101, and the program may be downloaded from another computer through a network. The auxiliary storage device 102 stores the installed program and also stores necessary files, data, and the like.

The memory device 103 reads the program from the auxiliary storage device 102 and stores the program in a case where an instruction for starting the program is given. The CPU 104 executes a function relating to the failure factor estimation apparatus 10 in accordance with the program stored in the memory device 103. The interface device 105 is used as an interface for connection to a network.

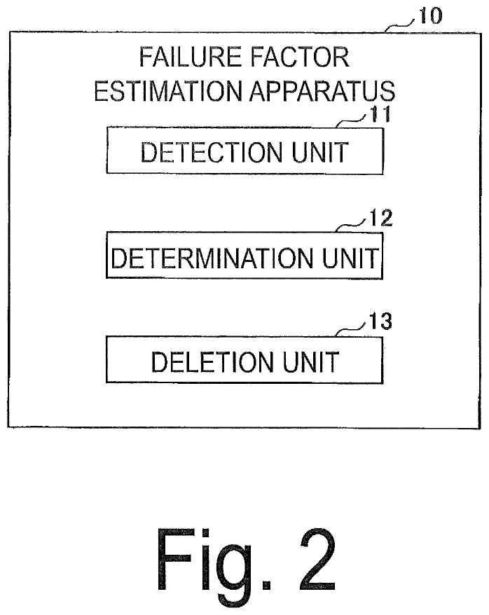

FIG. 2 is a diagram illustrating an exemplary functional configuration of the failure factor estimation apparatus 10 according to the embodiment of the present invention. In FIG. 2, the failure factor estimation apparatus 10 includes a detection unit 11, a determination unit 12, and a deletion unit 13. Each of these units is realized by processing that one or more programs installed in the failure factor estimation apparatus 10 cause the CPU 104 to execute.

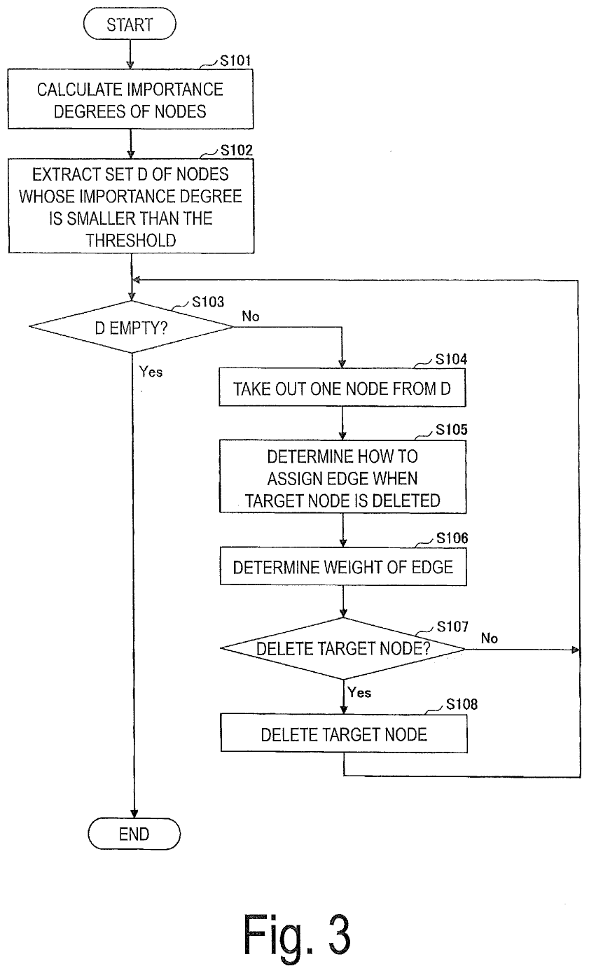

FIG. 3 is a flowchart for explaining an example of a processing procedure executed by the failure factor estimation apparatus 10.

In step S101, the detection unit 11 computes the importance degree of each node in the causal graph Gᵢ after changing in response to occurrence of the i-th failure.

When factor estimation in Gᵢ is made, bᵢ(v)=Pᵢ₋₁(v;Rᵢ₋₁) (when vϵV(Gᵢ₋₁)⊆V(Gᵢ) is satisfied) and bᵢ(v)=0 (when vϵV(Gᵢ\V(Gᵢ₋₁) is satisfied) are set. Note that Gᵢ₋₁ is a causal graph before occurrence of the i-th failure (i.e., before changing).

While an event v having a large bᵢ(v), i.e., a large factor degree in Gᵢ₋₁ is expected to have a high factor degree also in Gᵢ, for a newly added event uϵV(Gᵢ)\V(Gᵢ₋₁), there is a possibility that the event u has a high factor degree if the event u may be a factor for the event v having the large factor degree in Gᵢ₋₁. However, the computational load of factor degrees for nodes in Gᵢ is high. Thus, the detection unit 11 computes the importance degree that is an approximation of the factor degree (a value capable of approximating a magnitude relationship of factor degrees) and can be computed with a computational load lower than that of the factor degree, for each node of Gᵢ using the factor degree in Gᵢ₋₁.

The importance degree of vϵV(Gᵢ) is denoted as cᵢ(v) and cᵢ=[cᵢ(vᵢ), . . . , cᵢ(v_{N(Gi)})]^{T} is set. Furthermore, bᵢ=[bᵢ(v₁), . . . , bᵢ(v_{N(Gi)})]^{T} is set. It is assumed that the importance degree is bᵢ at time t=0 and cᵢ at time t=1. Consider a function dᵢ: [0,T]→R₊^{N(Gi)}, which connects bᵢ and cᵢ smoothly for time t. Let vⱼ be a newly added event in Gᵢ. Consider an amount of change of the j-th component of dᵢ during minute time t=0 to t=h. Let a set of nodes adjacent to vⱼ be

$$\{ {u}_{1} , … , {u}_{{d}_{{G}_{i}} ( {v}_{j} )} \} \qquad [ Math . 4 ]$$

The j-th component of dᵢ at t=h is considered to be obtained by multiplying each factor degree of uₖ (k=1, . . . , d_{Gi}(vⱼ)) by p({Xₖ=1} {Xⱼ=1}) and summing up the resulting products for k. This may prevent the importance degree of an event where a factor degree in Gᵢ may be relatively high from relatively lowering.

Specifically, the detection unit 11 computes the importance degree cᵢ: V(Gᵢ)→R₊ in Gᵢ as follows.

$$\begin{matrix}[ Math . 5 ] & \\ \frac{d}{d t} {d}_{i} = {A}_{i} {d}_{i} , {d}_{i} ( 0 ) = {b}_{i} \\ {c}_{i} := {d}_{i} ( 1 ) = {e}^{{A}_{i}} {b}_{i} & ( 1 )\end{matrix}$$

Here, Aᵢ represents an adjacency matrix A(Gᵢ) of Gᵢ.

As described below, the detection unit 11 considers v, in which the importance degree cᵢ(v) computed by Equations (1) is relatively low, to be less important in factor estimation, and selects it as a candidate for deletion. The following relationships are satisfied.

$$\begin{matrix}{c}_{i} ( {v}_{j} ) = {d}_{i , j} ( 1 ) \\ = {d}_{i , j} ( 0 ) + {\int }_{0}^{1} {( {A}_{i} {d}_{i} )}_{j} dt \\ \geq {\int }_{0}^{1} {\sum }_{{e}_{jk} ∈ E ( {G}_{i} )} {d}_{i , k} ( t ) {f}_{{G}_{i}} ( {e}_{j , k} ) dt \\ = {\sum }_{{e}_{jk} ∈ E ( {G}_{i} )} {\int }_{0}^{1} {d}_{i , k} ( t ) d t {f}_{{G}_{i}} ( {e}_{j , k} ) \\ \geq {\sum }_{{e}_{jk} ∈ E ( {G}_{i} )} {d}_{i , k} ( 0 ) {f}_{{G}_{i}} ( {e}_{j , k} ) \\ \geq {\sum }_{{e}_{jk} ∈ E ( {G}_{i} )} {\sum }_{v ∈ {R}_{i - 1}} {P}_{i - 1} ( {v}_{k} ; \{ v \} ) {f}_{{G}_{i}} ( {e}_{j , k} ) \\ \geq {\sum }_{v ∈ {R}_{i - 1}} ( 1 - {\prod }_{{e}_{jk} ∈ E ( {G}_{i} )} ( 1 - {P}_{i - 1} ( {v}_{k} ; \{ v \} ) {f}_{{G}_{i}} ( {e}_{j , k} ) ) ) \\ \vec{i \to ∞} {\sum }_{v ɛ R} ( 1 - {\prod }_{{e}_{jk} ∈ E ( G )} ( 1 - P ( {v}_{k} ; \{ v \} ) f ( {e}_{j , k} ) ) ) \\ = P ( {v}_{j} ; R )\end{matrix} \qquad [ Math . 6 ]$$

Here, an inequality in the fourth row uses a fact that each component of dᵢ monotonically increases with respect to t because all components of Aᵢ are positive. In addition, (Aᵢdᵢ)ⱼ represents the j-th component of Aᵢdᵢ. Thus, the importance degree cᵢ(v) is a value equal to or greater than the true factor degree P(v;R) at i→∞.

In addition, because each component of dᵢ monotonically increases, bᵢ(v)≤cᵢ(v) is satisfied for any vϵV(Gᵢ), and thus, a node having a relatively high factor degree in Gᵢ₋₁ is not deleted. This allows detection in consideration of point (1).

Subsequently, the detection unit 11 extracts a set of nodes where cᵢ(v) is less than or equal to a constant threshold cₘₐₓ (and substitutes the extracted set into D (S102). In other words, the following computation is performed.

D={vϵV(Gᵢ)|cᵢ(v)≤cₘₐₓ}

Subsequently, the determination unit 12 determines whether or not the node (node included in D) is present (whether or not D is empty) (S103). When there is no node (when D is empty) (Yes in S103), processing in FIG. 3 ends. When there is a node (No in S103), the determination unit 12 takes out one node from D (S104). The taken node is deleted from D. The taken node is referred to as “node vⱼ” below. Note that the order of taking out nodes is not limited to a specific order. For example, a node having the lowest importance degree cᵢ(v) may be taken out, a node having the lowest index may be taken out, or a node may be taken out randomly. The index is an identifier that is assigned to a node, for example, a numerical value indicating the order in which nodes were generated.

Subsequently, the determination unit 12 determines how to assign an edge when the node vⱼ is deleted (after deleting) (S105). Specifically, the determination unit 12 identifies a node vₖ at which the weight of an edge from vⱼ is the maximum, of the nodes adjacent to the node vⱼ, and regards vⱼ and vₖ as one node, thereby assigning an edge of vⱼ and an edge of vₖ to the one node.

The reason why a node at which the weight is the maximum is used is to minimize influence of change of a weight in the computation of factor degree before and after node deletion when the weight is determined in the manner described below.

Subsequently, the determination unit 12 determines the weight of each edge, the assignation manner of which is determined in step S105, so that in next three simple structures, the factor degree of each node does not change before and after node deletion (S106). In the following description, a graph before deletion of the node vⱼ is represented as G_{B}, and a graph after the deletion is represented as G_{A}.

Tree Structure

When no edge enters vⱼ or vₖ from a common node and no edge extends to the common node from vⱼ or vₖ (that is, the node vⱼ is a parent node of the node vₖ), all weights of edges from vₖ are multiplied by a weight f_{GB}(eⱼₖ) of the edge from vⱼ to vₖ to create f_{GA}. When the weight is determined in this way, the factor degree can be prevented from changing before and after node deletion for the tree.

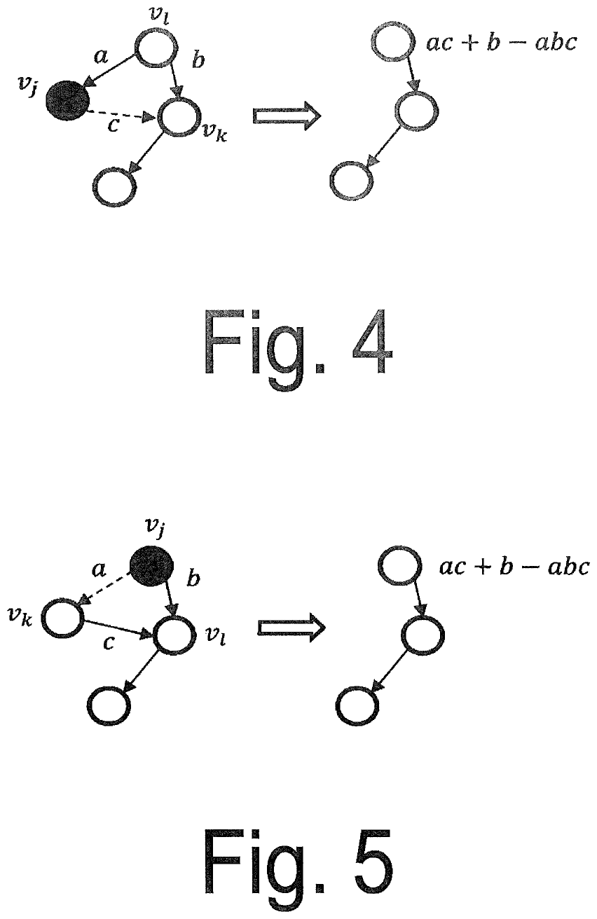

Structure in FIG. 4

When an edge enters to each of vⱼ and vₖ from the common node vₗ in G_{B}, three edges of eⱼₖ, eₗₖ, and eₗⱼ become one edge eₗₖ in G_{A} in step S105. The weight is determined by f_{GA}(eₗₖ)=f_{GB}(eₗⱼ)·f_{GB}(eⱼₖ)+f_{GB}(eₗₖ)−f_{GB}(eₗⱼ)·f_{GB}(eⱼₖ)·f_{GB}(eₗₖ). When the weight is determined in this way, the factor degree can be prevented from changing before and after node deletion for a structure such as that illustrated in FIG. 4. Note that in FIG. 4, a is f_{GB}(eₗⱼ), b is f_{GB}(eₗₖ), and c is f_{GB}(eⱼₖ).

Structure in FIG. 5

When an edge extends to the common node vₗ from each of vⱼ and vₖ in G_{B}, three edges of eⱼₖ, eₖₗ, and eⱼₗ become one edge eⱼₗ in G_{A} in step S105. The weight is determined by f_{GA}(eₖₗ)=f_{GB}(eₖₗ)·f_{GB}(eⱼₖ)+f_{GB}(eⱼₗ)−f_{GB}(eₖₗ)·f_{GB}(eⱼₖ)·f_{GB}(eⱼₗ). When the weight is determined in this way, the factor degree can be prevented from changing before and after node deletion for a structure such as that illustrated in FIG. 5. Note that in FIG. 5, in FIG. 4, a is f_{GB}(eⱼₖ), b is f_{GB}(eⱼₗ), and c is f_{GB}(eₖₗ).

Subsequently, the deletion unit 13 determines whether or not to delete the node vⱼ (S107). Specifically, the deletion unit 13 checks whether there is a cycle structure in G_{A} by checking an eigenvalue of an adjacency matrix of G_{A} when the graph before deleting the deletion candidate vⱼ is denoted as G_{B} and the graph after the deletion is denoted as G_{A}. Generally, for an adjacency matrix A(G) of a graph G, the following holds:

All eigenvalues of A(G) are 0

### => A(G)ⁿ=0

=> There is no path having a length equal to or greater than n in G.
=> There is no cycle structure in G.

Thus, if all the eigenvalues of A(G_{A}) are 0 (Yes in S108), the deletion unit 13 deletes vⱼ, and if all the eigenvalues of A(GA) are not 0 (No in S108), the deletion unit 13 does not delete vⱼ. Note that when vⱼ is deleted, the deletion unit 13 imparts an edge to the Gᵢ and a weight to the edge in accordance with the results of the steps S105 and S106.

Step S104 and subsequent steps are executed until D is empty. That is, step S104 and subsequent steps are executed for each vⱼ ϵD.

While a computation cost is high for computing an eigenvalue for a general matrix, the computation cost is reduced in this case for the following reason. Generally, if there is no cycle structure in a graph G, A(G) can be an upper triangular matrix. Thus, Gᵢ may be assumed to be an upper triangular matrix. The change from A(G_{B}) to A(G_{A}) is a change in the row and column corresponding to the node vₖ at which the weight of the edge from vⱼ is the maximum among nodes adjacent to vⱼ, and deletion of the row and column corresponding to the node vⱼ. In this change, only the change in the row and column corresponding to the node vₖ gives a change in the structure of the upper triangular matrix, and thus the number of components other than the upper triangular component of G_{A} is small. Thus, the computation amount necessary for QR decomposition required to numerically determine the eigenvalue of G_{A} is reduced.

Evaluation Results

The present embodiment was applied to a randomly created small graph to make an evaluation for “(1) A node that is likely to be a factor is left behind after summarization”, and “(2) There is less change in results of the factor estimation before and after summarization” of the above points (1) to (3).

Setting

The conditions described in the section “Problem Setting” were simulated and evaluated as follows.

1. A random graph G₁ having the number of nodes of 25 is created.
2. For each node vϵV(G₁) of G₁, the factor degree P₁(v; R₁) is computed letting R₁=V(G₁).
3. Nodes are added to G₁ so that the number of nodes is made 50 and edges are randomly added to create G₂.
4. Summarization is performed with the processing procedure illustrated in FIG. 3 to create a graph G′₂ after summarization.
5. Evaluation 1: In order to confirm that a difference in factor degree for each node is small before and after summarization when summarization is performed using the present embodiment, for each u, vϵV(G′₂), a difference P₂(v;{u})−P′₂(v;{u}) between P₂(v;{u}) and the factor degree P′₂ (v;{u}) computed in G′₂ is computed.
6. What is obtained by replacing randomly chosen five components of the source of R₁ with randomly chosen five components of the source of V(G₂)\R₁ is set as R₂.
7. Evaluation 2: In order to confirm that there is less difference in the upper 5 events extracted as major factors before and after summarization when summarization is performed using the present embodiment, the upper five vϵV(G₂) where P₂(v;R₂) increases and five vϵV(G′₂) where P′₂(v;R₂) increases are determined to be compared.

Results

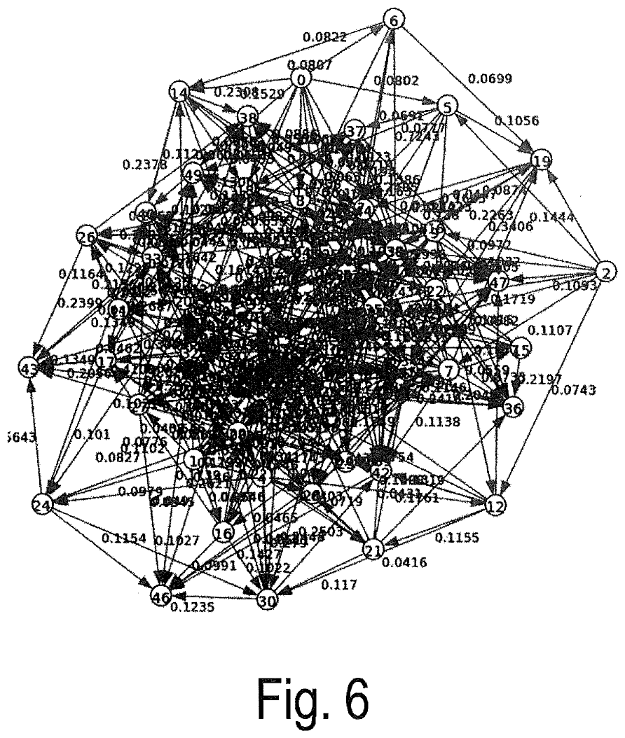

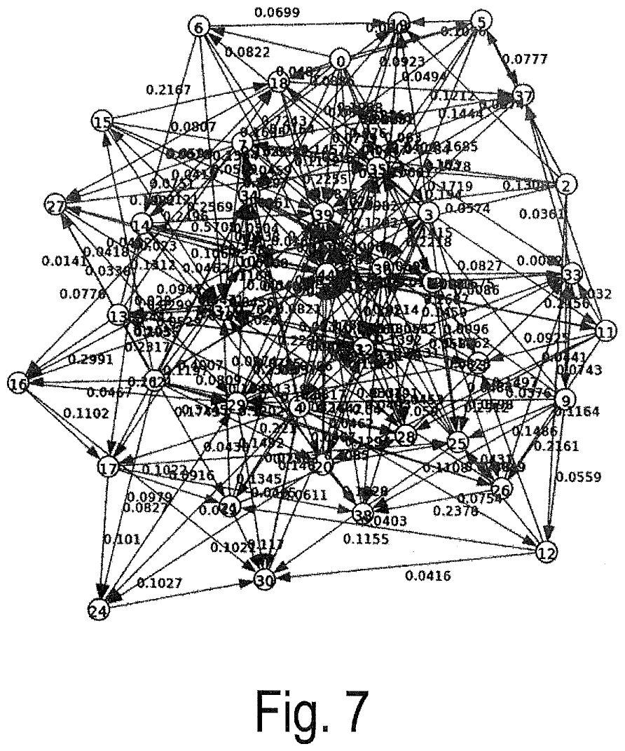

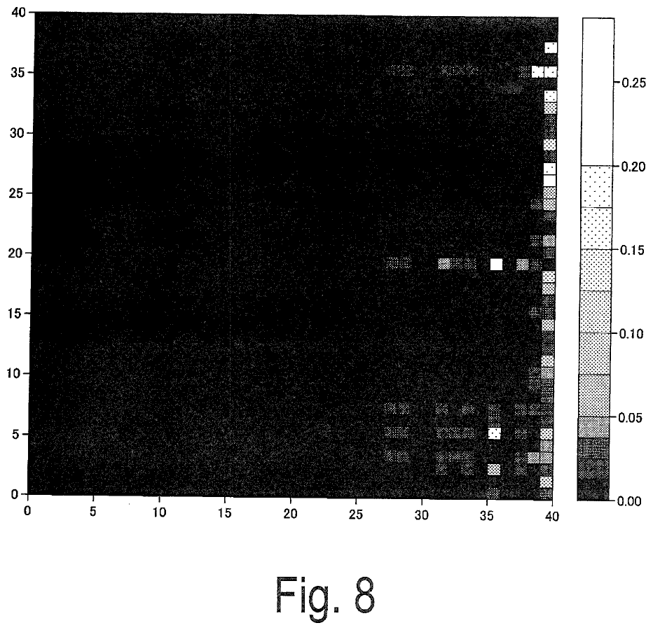

While the number of nodes was 50 in the graph G₂ before summarization, the number of nodes was 40 in the graph G′₂ after summarization. The graph G₂ before summarization is illustrated in FIG. 6, and the graph G′₂ after summarization is illustrated in FIG. 7.

Evaluation 1: For any node u, vϵV(G′₂) of the graph G′₂ after summarization, values of |P₂(v;{u})−P′₂(v;{u})| when the index of the node u is taken on the vertical axis and the index of the node v is taken on the horizontal axis are expressed using a heat map as illustrated in FIG. 8. For most of the u, v pairs, the values of |P₂(v;{u})−P′₂(v;{u})| were 0.1 or less. This indicates that when R₂={v} is assumed, the difference in factor degree of an event u is approximately within 0.1 before and after graph summarization.

Evaluation 2: Indices of the upper five vϵV(G₂) at which P₂(v;R₂) increases and indices of the five vϵV(G′₂) at which P′₂(v;R₂) increases were as shown in Table 1.

TABLE 1

| | P₂ (v; R₂) | P′₂ (v; R₂) |
|---|---|---|
| 1ST | 0 | 10 |
| 2ND | 10 | 0 |
| 3RD | 4 | 4 |
| 4TH | 2 | 9 |
| 5TH | 15 | 2 |

Although there are some interchanges of the order, four indices of the upper five events appear in both, and it can be seen that the results of factor estimation approximately match before and after summarization.

As described above, according to the present embodiment, propagation of past information is performed in a manner suitable for factor estimation by a causal graph, and based on the result, an unnecessary node is detected to summarize a graph. That is, past information is used to determine an importance degree of each node, thereby detecting vertices that are not critical. This importance degree can indicate convergence to a value greater than or equal to a true factor degree, and thus a node that is likely to be a factor can be left behind after summarization. As a result, graph summarization capable of suppressing a decrease in accuracy of factor estimation by a causal graph in system operation can be achieved.

In addition, in a simple structure, the weight of an edge is determined so that a factor degree does not change before and after deleting a node, thereby reducing a change in the result of factor estimation before and after summarization. Further, when an eigenvalue of an adjacency matrix is computed, it can be achieved that a graph after summarization does not have a cycle structure. When the structure of the adjacency matrix is considered, this eigenvalue computation can be achieved with a small computation amount.

That is, when a causal graph representing a causal relationship of an event obtained by a failure is summarized to leave behind an important event as possible and to reduce the influence on results of factor estimation as much as possible while maintaining the structure of the graph, factor estimation can be made faster with a certain degree of accuracy kept. Furthermore, when deleted vertices are recovered to make factor estimation again only around nodes with high factor degrees in the graph after summarization, it is possible to achieve additional accuracy. As a result, handling at the time of occurrence of a failure can be made faster while maintaining accuracy.

In the present embodiment, the failure factor estimation apparatus 10 is an example of a causal graph summarizing apparatus. The detection unit 11 is an example of a computation unit and a selection unit.

Although the embodiments of the present invention have been described above in detail, the present disclosure is not limited to such specific embodiments, and various modifications or changes can be made within the scope of the gist of the present disclosure described in the claims.

### REFERENCE SIGNS LIST

10 Failure factor estimation apparatus
11 Detection unit
12 Determination unit
13 Deletion unit
100 Drive device
101 Recording medium
102 Auxiliary storage device
103 Memory device
104 CPU
105 Interface device
B Bus

1. A graph summarizing apparatus comprising:
processing circuitry configured to:
detect a change in a graph having (i) nodes and edges, each edge connecting given nodes among the nodes, (ii) an influence degree that indicates an extent to which a factor influences a state of the graph being indicated for each node, and (iii) weights assigned to the respective edges, each weight indicating a strength of a causal relationship between given nodes that are connected by a corresponding edge;
upon detecting the change in the graph, compute, for each node of a post-change graph, an importance based on influence degrees for nodes in a pre-change graph, the post-change graph resulting from the detected change in the graph, and the pre-change graph being the graph;
select a first node from among nodes of the post-change graph, such that a given importance less than or equal to a threshold is set for the first node, wherein the first node is a candidate to be deleted; and
delete the first node.

2. The graph summarizing apparatus according to claim 1, wherein the processing circuitry is further configured to:
determine, for each of first nodes of the post-change graph, an edge to be assigned to the post-change graph upon occurrence of a condition in which a given first node is deleted, the determined edge being set based on one node that is set based on the given first node and a second node connected, via a given edge, to the given first node, a greatest weight, among weights assigned to one or more edges each of which connects the given first edge and a given node connected to the given first edge, being assigned to the given edge, and
determine a weight for the determined edge, such that a first influence degree used before the given first node is deleted is same as a second influence degree used after the given first node is deleted.

3. The graph summarizing apparatus according to claim 1, wherein the processing circuitry is configured to:
determine whether the post-change graph is a cycle graph, upon occurrence of a condition in which the first node of the post-change graph is deleted, and
delete the first node, upon determining that the post-change graph is not the cycle graph.

4. A graph summarizing method for execution by a computer, the method comprising:
detecting a change in a graph having (i) nodes and edges, each edge connecting given nodes among the nodes, (ii) an influence degree that indicates an extent to which a factor influences a state of the graph being indicated for each node, and (iii) weights assigned to the respective edges, each weight indicating a strength of a causal relationship between given nodes that are connected by a corresponding edge;
upon detecting the change in the graph, computing, for each node of a post-change graph, an importance based on influence degrees for nodes in a pre-change graph, the post-change graph resulting from the detected change in the graph, and the pre-change graph being the graph;
selecting a first node from among nodes of the post-change graph, such that a given importance less than or equal to a threshold is set for the first node, wherein the first node is a candidate to be deleted; and
deleting the first node.

5. The graph summarizing method according to claim 4, further comprising:
determining, for each of first nodes of the post-change graph, an edge to be assigned to the post-change graph upon occurrence of a condition in which a given first node is deleted, the determined edge being set based on one node that is set based on the given first node and a second node connected, via a given edge, to the given first node, a greatest weight, among weights assigned to one or more edges each of which connects the given first edge and a given node connected to the given first edge, being assigned to the given edge; and
determining a weight for the determined edge, such that a first influence degree used before the given first node is deleted is same as a second influence degree used after the given first node is deleted.

6. The graph summarizing method according to claim 4, wherein the deleting of the first node includes:
determining whether the post-change graph is a cycle graph, upon occurrence of a condition in which the first node of the post-change graph is deleted, and
deleting the first node, upon determining that the post-change graph is not the cycle graph.

7. A non-transitory computer readable medium storing a program that causes a computer to execute the graph summarizing method according to claim 4.
